(19) United States
(12) Patent Application Publication
(10) Pub. No.: US 2010/0073520 A1
(43) Pub. Date: Mar. 25, 2010

(54) IMAGE BRIGHTNESS COMPENSATION METHOD AND DIGITAL CAMERA DEVICE WITH IMAGE BRIGHTNESS COMPENSATION FUNCTION

(75) Inventors: Chan-Min Chou, Taipei County (TW); Chung-Pin Lu, Taipei County (TW)

Correspondence Address: RABIN & Berdo, PC, 1101 14TH STREET, NW, SUITE 500, WASHINGTON, DC, 20005, US

(73) Assignee: Altek Corporation, Hsinchu (TW)

(21) Appl. No.: 12/328,923

(22) Filed: Dec. 5, 2008

(30) Foreign Application Priority Data
Sep. 19, 2008 (TW) 097136087

(51) Int. Cl. H04N 5/235

(52) U.S. Cl. 348/234; 348/E05.034

(57) ABSTRACT

An image brightness compensation method and a digital camera device with an image brightness compensation function are suitable for adjusting a brightness of a digital image shot by a digital camera device, especially when the shot object is located outside a maximum output range of a flash lamp. The method includes the steps of pre-capturing a target image, and recording target information; triggering a flash lamp, and meanwhile capturing a raw image; determining whether the raw image satisfies a brightness threshold or not according to a brightness difference between the target information and the raw image; if the raw image fails to satisfy the brightness threshold, executing a brightness compensation program on the raw image according to the target information; and finally, generating an output image.

### CROSS-REFERENCE TO RELATED APPLICATIONS

This non-provisional application claims priority under 35 U.S.C. §119(a) on Patent Application No(s). 097136087 filed in Taiwan, R.O.C. on Sep. 19, 2008 the entire contents of which are hereby incorporated by reference.

### BACKGROUND OF THE INVENTION

1. Field of the Invention

The present invention relates to an image processing method and a device thereof, and more particularly to an image brightness compensation method and a digital camera device.

2. Related Art

As camera devices having been increasingly prevailing, they are more and more widely used in various applications. When a camera device is used for shooting an image, the shooting brightness may directly affect the quality and recognizability of the final image. Especially, when the light in the shooting site is inadequate or the exposure time fails to meet the requirement of the safety shutter, a flash lamp is required to compensate the brightness of the shooting environment. Therefore, the brightness of the shot image is compensated by the flash lamp, such that the shot image may not have any unrecognizable area due to the excessively inadequate brightness.

FIG. 1A is a flow chart of shooting an image with a flash lamp in the prior art. First, a pre-flash is fired and a pre-flash image is shot (Step S110). An automatic exposure time of a camera device is captured (Step S120). A main flash duration is estimated according to the pre-flash image and the automatic exposure time (Step S130). Generally, the flash lamp has two activation modes, i.e., full-flash activation and main-flash activation. In the full-flash activation mode, the flash lamp is set at the maximum output level, i.e., the maximum range covered by the flash lamp. In the main-flash activation mode, the flash lamp is set at a corresponding output according to a distance from the shot object (generally a distance within the range of the full flash).

Then, a main flash is fired according to the main flash duration, and a raw image is shot (Step S140). Finally, an image processing is performed on the raw image, so as to output a preset image file (Step S150). Through the above steps, when capturing an image, the camera device determines the occasion when a flash lamp is needed for image shooting. Furthermore, FIG. 1B is a schematic view of experimental data of a conventional flash output compensation brightness.

The conventional camera device has to fire a pre-flash before shooting, so as to detect a distance between the camera device and the shot object. In order to detect the distance between the camera device and the shot object, a detection unit and a corresponding circuit need to be additionally disposed in the camera device. As such, not only the volume and weight of the camera device are increased, but the manufacturing cost also rises.

### SUMMARY OF THE INVENTION

In order to solve the above problems, the present invention is mainly directed to an image brightness compensation method, suitable for adjusting a brightness of a digital image shot by a digital camera device, especially when the shot object is located outside a maximum output range of a flash lamp.

To achieve the above objective, the present invention provides an image brightness compensation method, which includes the steps of: pre-capturing a target image, and recording a target information; triggering a flash lamp, and meanwhile capturing a raw image; determining whether the raw image satisfies a brightness threshold or not according to a brightness difference between the target information and the raw image; if the raw image fails to satisfy the brightness threshold, executing a brightness compensation program on the raw image according to the target information; and finally generating an output image.

The present invention is further directed to a digital camera device with an image brightness compensation function.

To achieve the above objective, the present invention provides a digital camera device with an image brightness compensation function, which includes a photo-sensitive unit, a flash lamp, a storage unit, a brightness compensation program, and a processing unit. The photo-sensitive unit captures a signal of a digital image. The flash lamp performs brightness compensation on an external environment of the digital image. The storage unit is electrically connected to the photo-sensitive unit, for storing the brightness compensation program and the digital image. The processing unit is electrically connected to the photo-sensitive unit, the flash lamp, and the storage unit, for executing the brightness compensation program. The brightness compensation program includes the steps of: pre-capturing a target image, and recording a target information; triggering the flash lamp, and meanwhile capturing a raw image; determining whether the raw image satisfies a brightness threshold or not according to a brightness difference between the target information and the raw image; if the raw image fails to satisfy the brightness threshold, executing a brightness compensation program on the raw image according to the target information; and generating an output image after the brightness compensation.

The present invention provides a digital image brightness compensation method and a digital camera device. Therefore, a desired compensation effect of a flash lamp at an appropriate intensity can be achieved without firing a pre-flash.

### BRIEF DESCRIPTION OF THE DRAWINGS

The present invention will become more fully understood from the detailed description given herein below for illustration only, and thus is not limitative of the present invention, and wherein:

FIG. 1A is a flow chart of shooting an image with a flash lamp in the prior art.

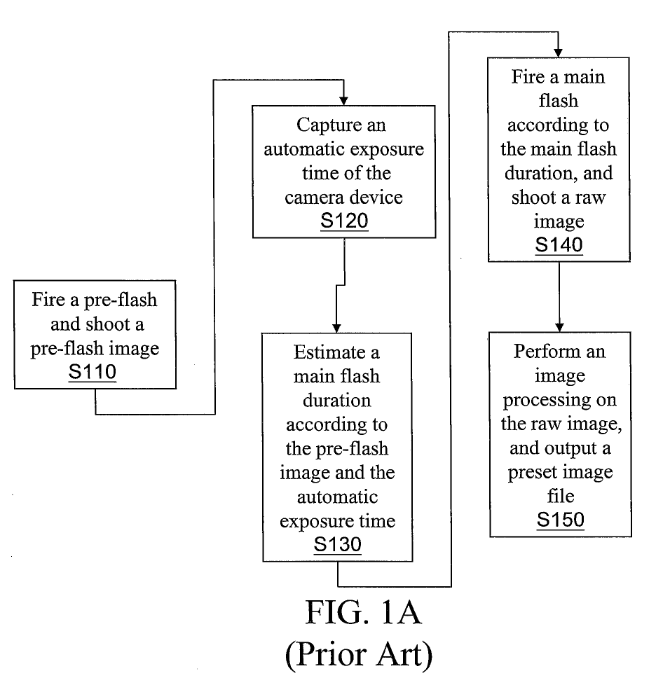

FIG. 1B is a schematic view of experimental data of a conventional flash output compensation brightness.

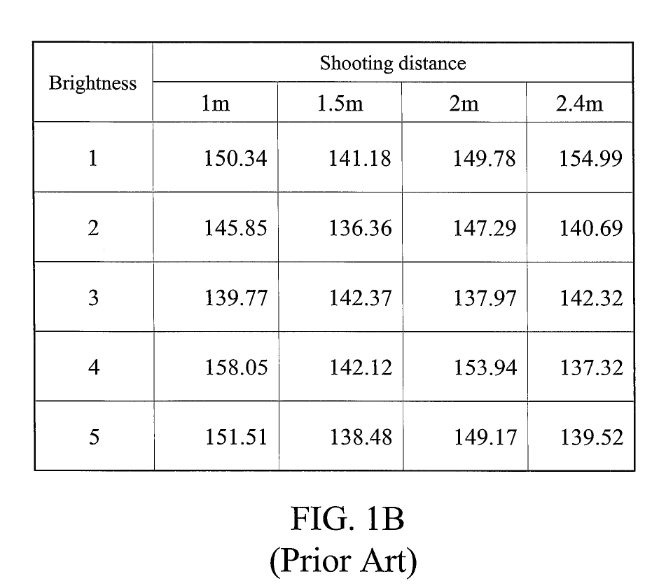

FIG. 2 is a schematic architectural view of the present invention.

FIG. 3 is a schematic flow chart of the present invention.

FIG. 4A is a schematic view of an operation of an implementation aspect of the present invention.

FIG. 4B is a comparison diagram of a brightness difference between a target image and a raw image.

FIG. 4C is a curve diagram of a face brightness in the target image and the raw image.

FIG. 4D shows experimental data of a brightness of the raw image after being adjusted.

### DETAILED DESCRIPTION OF THE INVENTION

The objective and method of the present invention are described in detail below through preferred embodiments, and the concept of the present invention may also be applied to other scopes. The following embodiments are only intended to illustrate the objective and method of the present invention, instead of limiting the scope of the present invention.

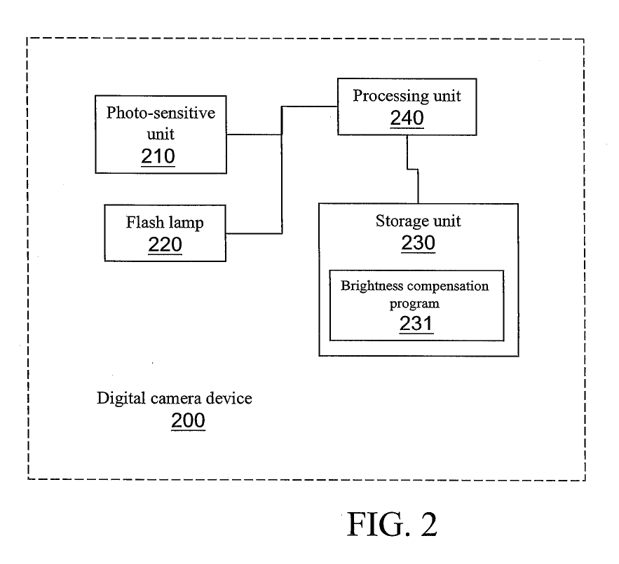

FIG. 2 is a schematic architectural view of the present invention. A digital camera device 200 includes a photo-sensitive unit 210, a flash lamp 220, a storage unit 230, a brightness compensation program 231, and a processing unit 240. The photo-sensitive unit 210 receives a photoelectric signal of a shot object. The flash lamp 220 performs external brightness compensation on the shot object. The storage unit 230 is electrically connected to the photo-sensitive unit 210, for storing the brightness compensation program 231 and the digital image. The processing unit 240 is electrically connected to the photo-sensitive unit 210, the flash lamp 220, and the storage unit 230, for executing the brightness compensation program 231.

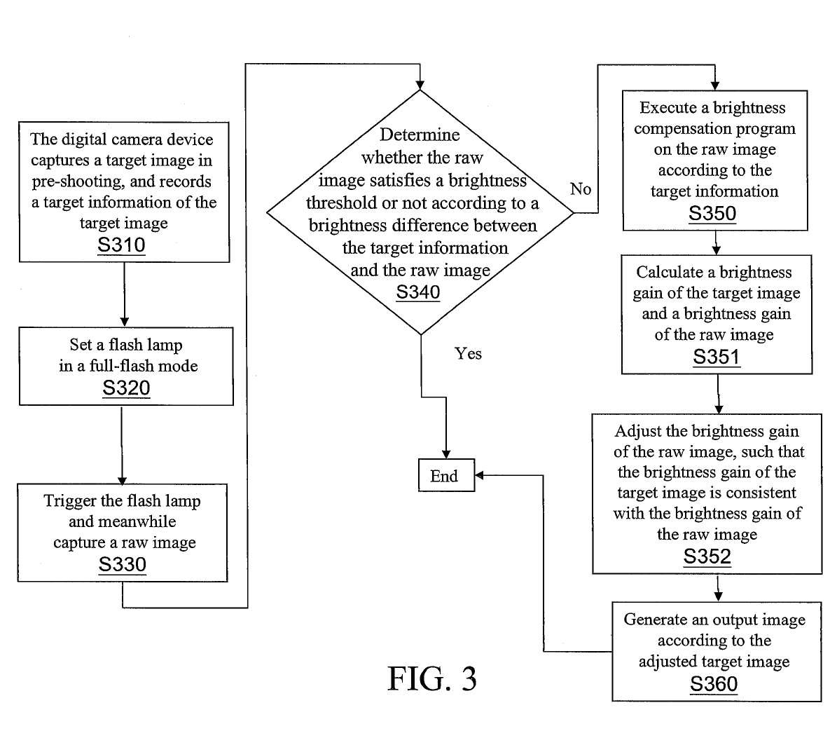

FIG. 3 is a schematic flow chart of the present invention. First, the digital camera device 200 captures a target image in pre-shooting, and records a target information of the target image (Step S310). The pre-shooting in the present invention means that the digital camera device 200 shoots a target image of the shot object during automatic focusing. The target information includes face brightness, face color, face coverage, or face location in the target image. Next, a flash lamp is set in a full-flash mode (Step S320). Then, the flash lamp is triggered and meanwhile a raw image is captured (Step S330). The raw image is in a RAW image data format. In addition, the raw image further includes image information of the shot object, so as to record the brightness, color, or contrast of the shot object.

It is determined whether the raw image satisfies a brightness threshold or not according to a brightness difference between the target information and the raw image (Step S340). If the raw image fails to satisfy the brightness threshold, a brightness compensation program is executed on the raw image according to the target information (Step S350). A brightness gain of the target image and a brightness gain of the raw image are calculated (Step S351). The brightness gain of the raw image is adjusted, such that the brightness gain of the target image is consistent with the brightness gain of the raw image (Step S352). Finally, an output image is generated according to the adjusted target image (Step S360). An example is given below to clearly illustrate the spirit of the present invention, and the adopted parameters are not limited herein.

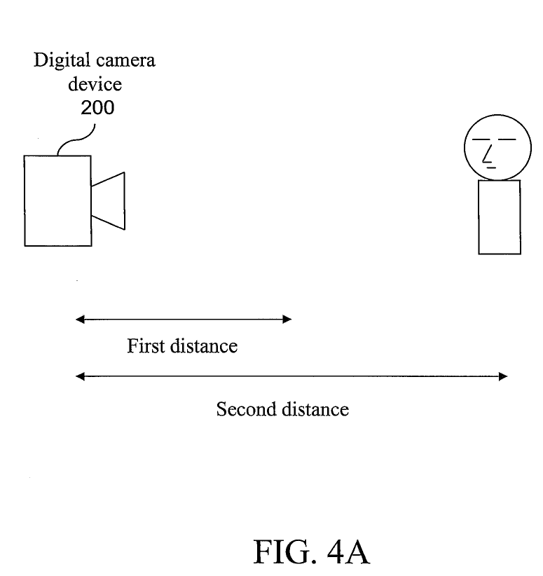

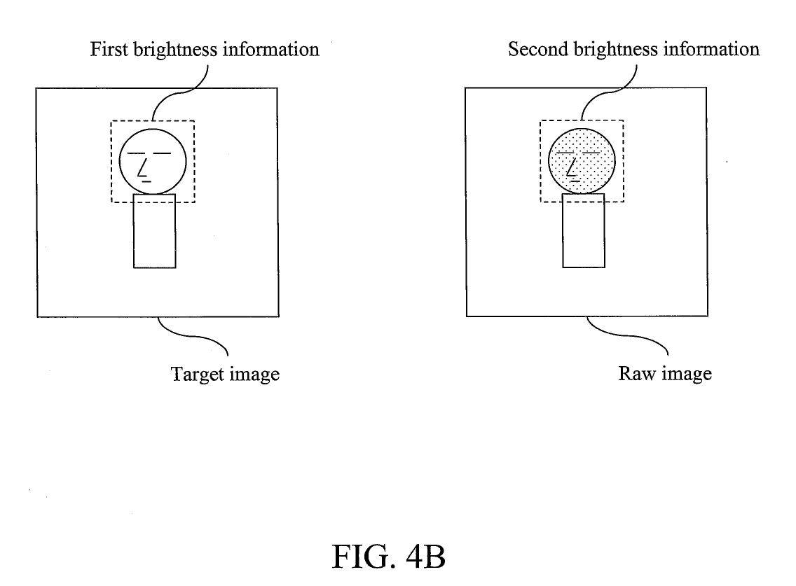

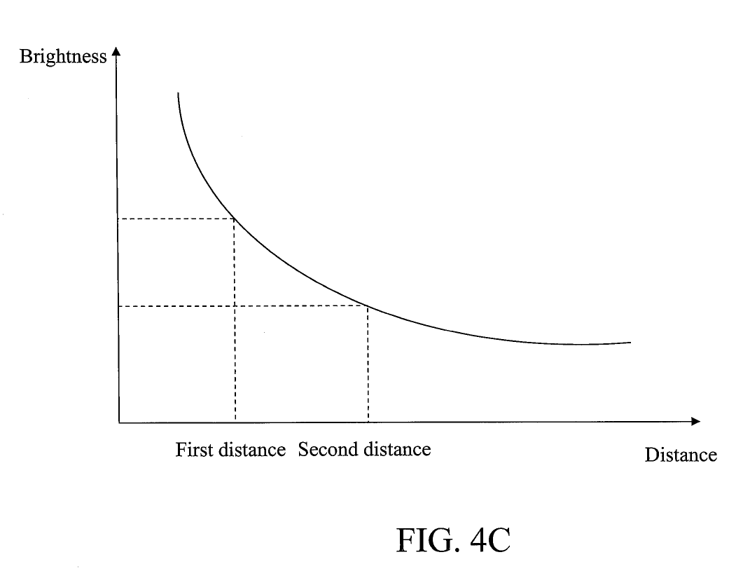

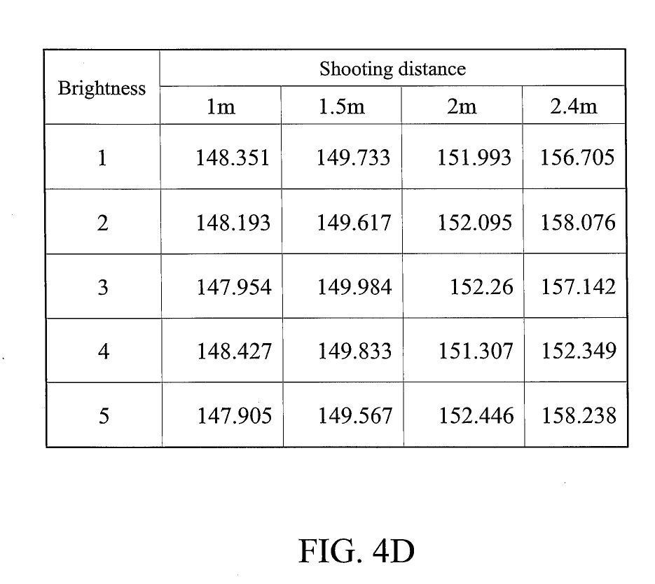

FIG. 4A is a schematic view of an operation of an implementation aspect of the present invention. First, the digital camera device 200 pre-shoots a target image during focusing. The target image at least includes a shot object, and the shot object is defined as a face image herein, which definitely may be set as a person with a complete body shown on the image. Furthermore, much information about the face image is obtained from the target image.

Then, an output mode of the flash lamp 220 is set in a full-flash activation mode. The farthest coverage of the full-flash activation mode is set as a first distance. The distance between the shot object and the digital camera device 200 is set as a second distance. The digital camera device 200 activates the flash lamp 220 when shooting a raw image, so as to obtain an image of the shot object compensated by the flash lamp 220. As the movement of the shot object may not be too abrupt during the process from automatic focusing to shooting, it is assumed that the displacement variation of the shot object in the target image and that in the raw image can be ignored.

It is determined whether the raw image satisfies a brightness threshold or not according to a brightness difference between the target information and the raw image. In this implementation aspect, the target information is, for example, the face brightness. FIG. 4B is a comparison diagram of a brightness difference between a target image and a raw image. In FIG. 4B, the target image of the face image is shown on the left, and the raw image thereof is shown on the right. In order to demonstrate the brightness information of the face image, the target image has a first brightness information, and the raw image has a second brightness information. The processing unit 240 takes the first brightness information of the target image as a brightness target value to be reached by the subsequently shot raw image. Due to being lack of light, the face portion in the raw image is covered by a black mesh shade in FIG. 4B.

Next, the processing unit 240 compares the second brightness information of the raw image with the first brightness information. As the shot object in the raw image is located outside the maximum output range of the flash lamp 220, the lights received by the shot object from the flash lamp 220 are insufficient when the raw image is shot. Thus, the raw image is adjusted according to the brightness information of the target image. FIG. 4C is a curve diagram of a face brightness in the target image and the raw image. In this implementation aspect, the brightness of the target information is compared with that of the original information, and if the brightness difference there-between exceeds the brightness threshold, the brightness compensation program 231 is executed.

If the raw image fails to satisfy the brightness threshold, the processing unit 240 executes the brightness compensation program 231, so as to adjust the brightness of the raw image to the brightness level of the target image. Particularly, a brightness gain of the target image and a brightness gain of the raw image are calculated. The brightness gain of the raw image is adjusted, such that the brightness gain of the target image is consistent with the brightness gain of the raw image. FIG. 4D shows experimental data of a brightness of the raw image after being adjusted. In addition to the aforementioned implementation aspect, the present invention may further combine the face coverage with the face brightness to serve as the information for adjusting the raw image.

The present invention provides a digital image brightness compensation method and a digital camera device. Therefore, a desired compensation effect of the flash lamp 220 at an appropriate intensity can be achieved without firing a pre-flash.

What is claimed is:

1. An image brightness compensation method, adapted to adjust a brightness of a digital image shot by a digital camera device, especially when the shot object is located outside a maximum output range of a flash lamp, the method comprising:
pre-capturing a target image, and recording a target information;
setting a flash lamp in a full-flash mode, and meanwhile capturing a raw image, wherein the raw image is in a RAW image data format;
determining whether the raw image satisfies a brightness threshold or not according to a brightness difference between the target information and the raw image;
if the raw image fails to satisfy the brightness threshold, executing a brightness compensation program on the raw image according to the target information; and
generating an output image.

2. The image brightness compensation method according to claim 1, wherein the target information comprises face contrast, face brightness, face color, face coverage, or face location.

3. The image brightness compensation method according to claim 1, wherein the raw image further comprises image information about face contrast, face brightness, face color, face coverage, or face location after the raw image is irradiated by the flash lamp.

4. The image brightness compensation method according to claim 1, wherein the brightness compensation program further comprises:
calculating a brightness gain of the target image and a brightness gain of the raw image; and
adjusting the brightness gain of the raw image, such that the brightness gain of the target image is consistent with the brightness gain of the raw image.

5. A digital camera device with an image brightness compensation function, adapted to adjust a brightness of a digital image shot by a digital camera device, especially when the shot object is located outside a maximum output range of a flash lamp, the digital camera device comprising:
a photo-sensitive unit, for capturing a signal of the digital image;
a flash lamp, for performing a brightness compensation on an external environment of the digital image;
a storage unit, electrically connected to the photo-sensitive unit, for storing a brightness compensation program and the digital image; and
a processing unit, electrically connected to the photo-sensitive unit, the flash lamp, and the storage unit, for executing the brightness compensation program, wherein the brightness compensation program further comprises:
pre-capturing a target image, and recording a target information;
triggering the flash lamp, and meanwhile capturing a raw image;
determining whether the raw image satisfies a brightness threshold or not according to a brightness difference between the target information and the raw image;
if the raw image fails to satisfy the brightness threshold, executing a brightness compensation program on the raw image according to the target information; and
generating an output image.

6. The digital camera device with an image brightness compensation function according to claim 5, wherein the target information comprises face brightness, face color, face coverage, or face location.

7. The digital camera device with an image brightness compensation function according to claim 5, wherein the raw image is in a RAW image data format.

8. The digital camera device with an image brightness compensation function according to claim 5, wherein the raw image further comprises image information about face contrast, face brightness, face color, face coverage, or face location after the raw image is irradiated by the flash lamp.
